(19) United States
(12) Patent Application Publication
(10) Pub. No.: US 2005/0125491 A1
(43) Pub. Date: Jun. 9, 2005

(54) Information processing apparatus and method

(76) Inventors: Tetsuo Hasegawa, Tokyo (JP); Hoang Pham Huy, Hanoi (VN); Takahiro Kawamura, Kanagawa-ken (JP)

Correspondence Address: Finnegan, Henderson, Farabow,;Garrett & Dunner, L.L.P., 1300 I Street, N.W., Washington, DC, 20005-3315, US

(21) Appl. No.: 10/986,062

(22) Filed: Nov. 12, 2004

(30) Foreign Application Priority Data
Nov. 14, 2003 (JP) P2003-385634

(51) Int. Cl. G06F 15/16

(52) U.S. Cl. 709/202; 709/201

(57) ABSTRACT

An analysis unit receives a sample of request data sent from a browser to a Web application. The browser and the Web application communicate data using HTTP protocol. The Web application receives the request data using GET method or POST method. The analysis unit analyzes a rule of HTTP protocol based on the sample. The rule includes a number of the request data, a name of the request data, and a format of response data corresponding to the request data. A generation unit generates a protocol converter to connect a communication of a Web service with a communication of the Web application based on the rule.

### CROSS-REFERENCE TO RELATED APPLICATIONS

This application is based upon and claims the benefit of priority from prior Japanese Patent Application P2003-385634, filed on Nov. 14, 2003; the entire contents of which are incorporated herein by reference.

### FIELD OF THE INVENTION

The present invention relates to an information processing apparatus and method for combining a Web application for a browser with a Web service for a computer by analysis and conversion of a protocol.

### BACKGROUND OF THE INVENTION

Recently, in proportion to development of a semiconductor technique and an IP (Internet protocol) technique, a communication network such as an Internet or a company LAN is widely used. As a typical information system used via such communication network, a Web application exists. The Web application is a system on a Web server utilized by a person from a browser. Based on a communication protocol (HTTP) between the browser and the Web server prescribed by International Standard, a user can utilize the Web application from the browser usually used irrespective of a vendor or a product of the Web server. Accordingly, the Web application is convenient for both the user and a provider. Many applications to be utilized by unspecified or specified majority are disclosed as the Web application.

On the other hand, recently, a Web service client application (hereinafter, it is called “Web service”) is also widely used. The Web service is a technique to utilize from an information system to another information system without an operator (user) between companies. For example, in order and acceptance of order between companies, by applying the Web service to an order side system and an acceptance side system, unmanned or automated order and acceptance of order can be realized.

A large number of users utilize many Web applications using a browser. By working an equivalent function of the Web service on the Web application and combining the Web application with the outside Web service such as business connections, it is desired that use relationship between the Web application and the Web service is directly concluded. However, in the Web application and an application of the Web service, though main contents of business processing are commonly used, a protocol for communication, i.e., a communication method such as an invocation and a result response, and transfer data format, are largely different. Accordingly, a communication part related to the protocol must be changed.

A difference of the communication part is explained. First, the Web application of a Web server side transfers data by communicating with browser at a client side using HTTP protocol. Especially, in a request communication from a browser to the Web server side, the Web application receives data by a data extraction method such as a GET method or a POST method indicated in a message. As a typical data transferred using such method, a request (an input) from the browser to the Web application is string type data of arbitrary units, and a response from the Web application to the browser is string type data having one tree structure such as HTML. The request and the response are stored in a message format peculiar to HTTP and transferred.

On the other hand, in the Web service, each application of a server side and a client side transfer data by communication using SOAP protocol. As a typical data of bidirection in this case, arbitrary type data of arbitrary units are stored in a format such as XML and transferred.

To change the above-mentioned communication part, analysis of transfer data of the existing Web application, analysis and creation of format data for the Web service, and development of communication of SOAP protocol, are necessary. Accordingly, working of very long time by an expert programmer is necessary, and a burden such as required time and cost is large. A technique to convert a message between the Web application and the Web service based on contents of the message is disclosed in Japanese Patent Disclosure (Kokai) 2002-175274. However, this is not a concrete technique to solve above-mentioned problem.

### SUMMARY OF THE INVENTION

The present invention is directed to an information processing apparatus and method able to combine the Web application for human use with the Web service for computer use by analysis and conversion of a protocol.

According to an aspect of the present invention, there is provided an information processing apparatus, comprising: an analysis unit configured to receive a sample of request data from a browser to a Web application, the browser and the Web application communicating data using a predetermined protocol, the Web application receiving the request data using a predetermined data extraction method, and to analyze a rule of the predetermined protocol based on the sample, the rule including a number of the request data, a name of the request data, and a format of response data corresponding to the request data; and a generation unit configured to generate a protocol converter to connect a communication of a Web service with a communication of the Web application based on the rule.

According to another aspect of the present invention, there is also provided an information processing method, comprising: receiving a sample of request data from a browser to a Web application, the browser and the Web application communicating data using a predetermined protocol, the Web application receiving the request data using a predetermined data extraction method; analyzing a rule of the predetermined protocol based on the sample, the rule including a number of the request data, a name of the request data, and a format of response data corresponding to the request data; and generating a protocol converter to connect a communication of a Web service with a communication of the Web application based on the rule.

According to still another aspect of the present invention, there is also provided a computer program product, comprising: a computer readable program code embodied in said product for causing a computer to process information, said computer readable program code comprising: a first program code to receive a sample of request data from a browser to a Web application, the browser and the Web application communicating data using a predetermined protocol, the Web application receiving the request data using a predetermined data extraction method; a second program code to analyze a rule of the predetermined protocol based on the sample, the rule including a number of the request data, a name of the request data, and a format of response data corresponding to the request data; and a third program code to generate a protocol converter to connect a communication of a Web service with a communication of the Web application based on the rule.

### BRIEF DESCRIPTION OF THE DRAWINGS

FIG. 1 is a block diagram of an information processing apparatus according to one embodiment of the present invention.

FIG. 2 is one example of a display on which URL is extracted from an address input area of a browser according to one embodiment of the present invention.

FIG. 3 is one example of a display on which analysis function result is output according to one embodiment of the present invention.

FIG. 4 is a flow chart of an analysis processing of GET protocol according to one embodiment of the present invention.

FIG. 5 is a flow chart of an analysis processing of POST protocol according to one embodiment of the present invention.

FIG. 6 is one example of request data of POST protocol according to one embodiment of the present invention.

FIG. 7 is one example of analysis result of the request data of FIG. 6 according to one embodiment of the present invention.

FIG. 8 is one example of a display on which analysis result of response data is output according to one embodiment of the present embodiment.

FIG. 9 is a flow chart of display processing of analysis result of response data according to one embodiment of the present invention.

FIG. 10 is one example of identifiers added to each analyzed datum on a display according to one embodiment of the present embodiment.

FIG. 11 is one example of a mapping rule to convert contents of transfer data on a display according to one embodiment of the present invention.

FIG. 12 is a flow chart of generation processing of a conversion unit according to one embodiment of the present invention.

### DETAILED DESCRIPTION OF THE EMBODIMENTS

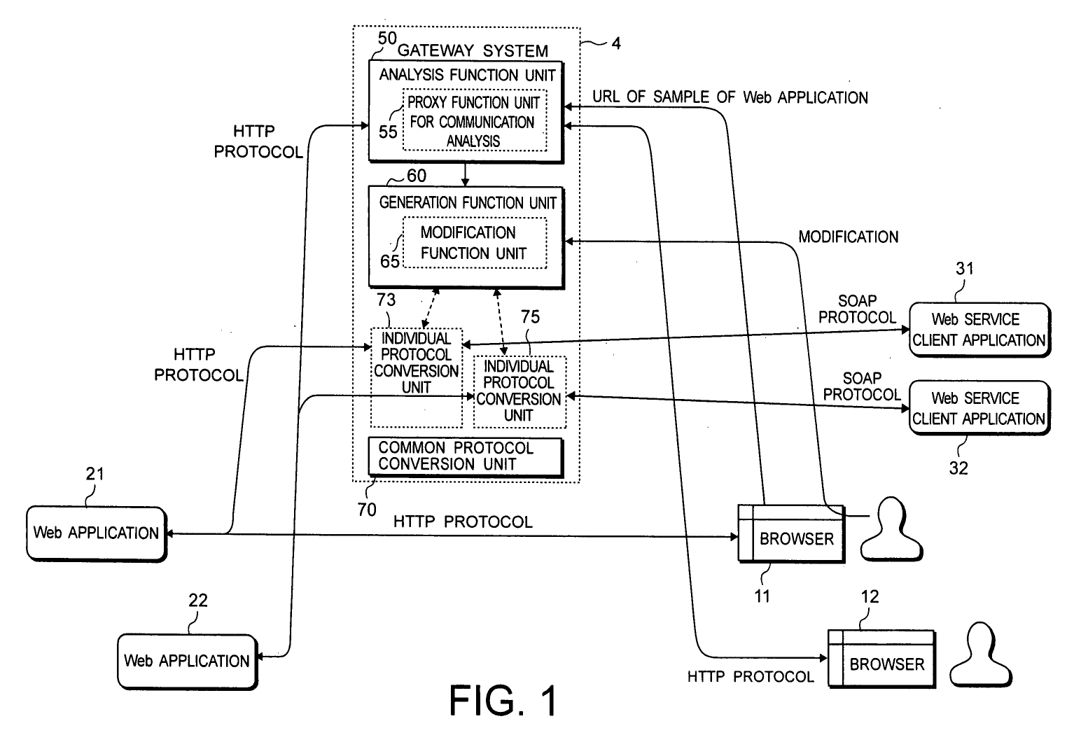

Hereinafter, various embodiments of the present invention will be explained by referring to the drawings. FIG. 1 is a block diagram of an information processing system according to one embodiment of the present invention.

As shown in FIG. 1, the information processing system 4 of the present embodiment mediates between Web applications 21 and 22 of a server side and Web service client applications 31 and 32. The Web applications 21 and 22 are originally used by persons from browsers 11 and 12. The Web service client applications 31 and 32 originally work without a person. This information processing apparatus is called a gateway system 4. Hereinafter, it is called “the present system”.

The present system 4 is packaged as a proxy server between a server computer system (not shown in FIG. 1) in which the Web applications 21 and 22 work and a client computer system (not shown in FIG. 1) in which the Web service client applications 31 and 32 work. For example, the present system 4 realizes the following each element in FIG. 1 by a computer executing a predetermined program. In addition to the apparatus, the present system 4 can be realized by such program and information processing method. Each element in FIG. 1 is composed as a unit operating as follows.

First, an analysis function unit 50 (It is also called “analysis function”.) receives URL for invocation of the Web application, request data of invocation (It is also called “giving data” or “giving message”), and response data (It is also called “receiving data”) as a result corresponding to the request data in communication for the Web application based on GET protocol or POST protocol. The request data and the response data are called “transfer data”. The analysis function unit 50 receives an input of an example of the transfer data. Based on the example of the transfer data, the analysis function unit 50 analyzes a rule of connection protocol including a number of the request data, a name of the request data, and a format of response data corresponding to the request data. As the response data as an object of format analysis, an example may be input as mentioned-above. However, by actually sending the example of the request data to the Web application as a target, the response data may be automatically acquired from the Web application.

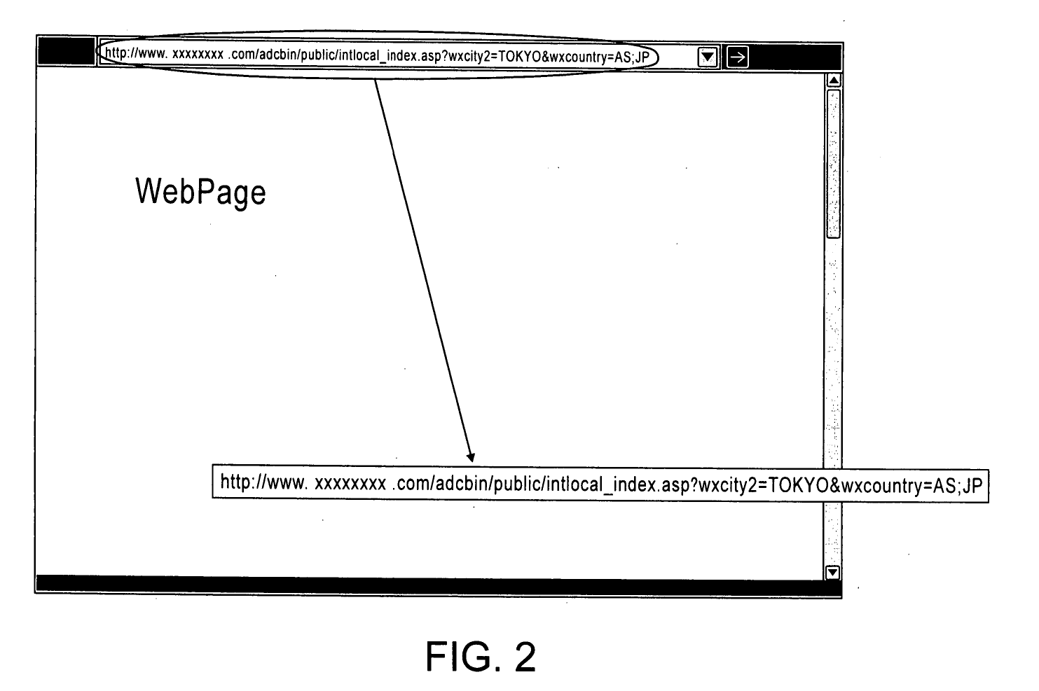

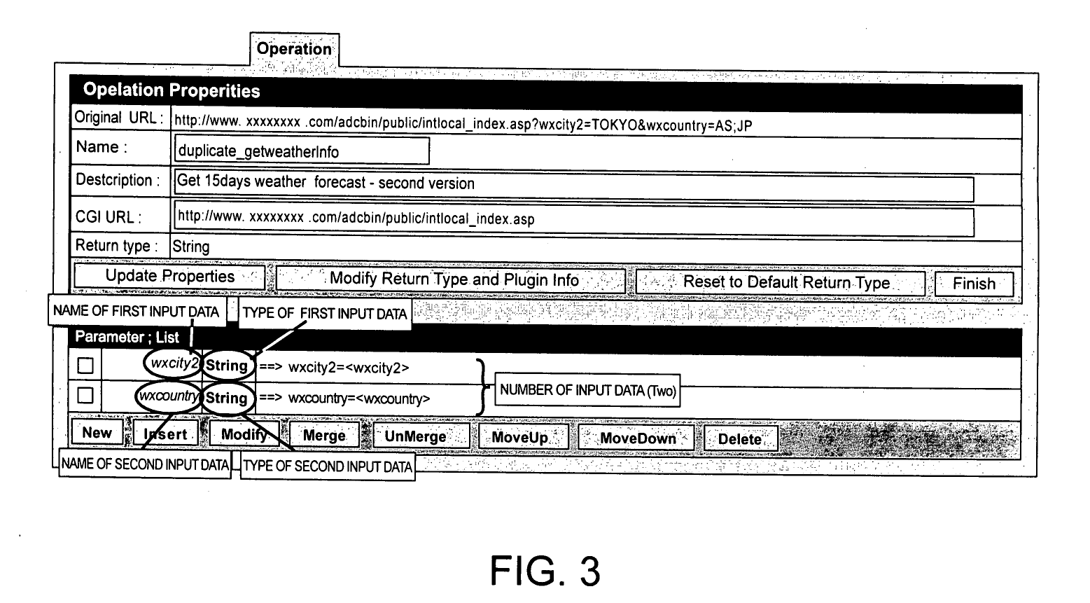

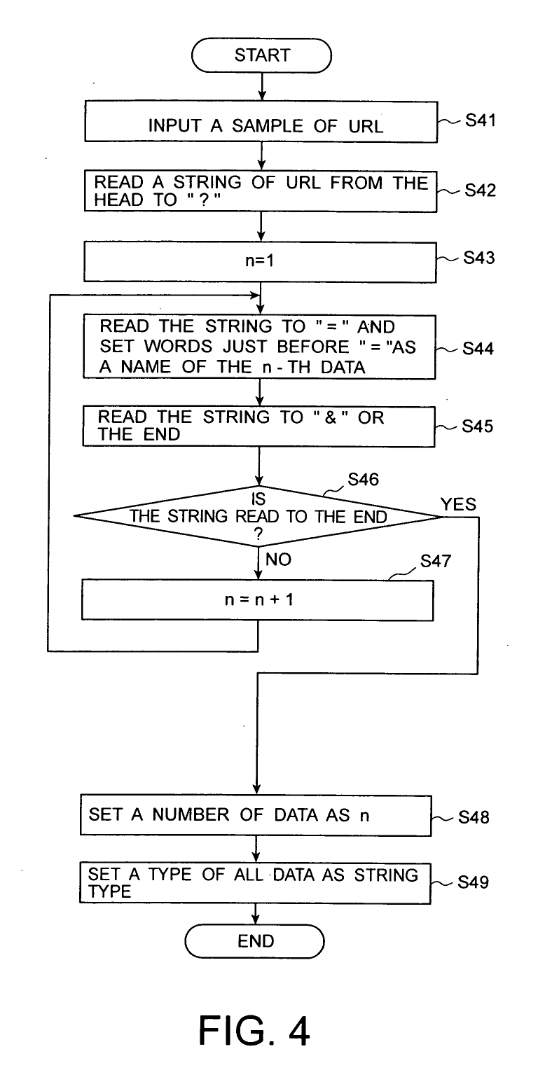

FIG. 2 is a display example in which URL is extracted from an address area of a browser. FIG. 3 is a display example in which analysis function result is output. FIG. 4 is a flow chart of an analysis processing of GET protocol. First, in a situation that a user accesses the Web application 21 from a browser 11, URL displayed on the address area is copied (FIG. 2) and input on a CGI URL area of screen of the analysis function unit 50 (FIG. 3) in response to the user's operation. The analysis function unit 50 analyzes the number of the request data and the name of the request data to be sent to the Web application by processing of the flow chart in FIG. 4. In this processing, from the head of string in the example of URL (S41, S42), each data is extracted based on a predetermined end character (S43˜S47). This extraction result is used as the original form of request data to the Web application (S48, S49). As shown in the lower part of FIG. 3, the original form is preserved as request data information and provided to a generation function unit 60 afterwards.

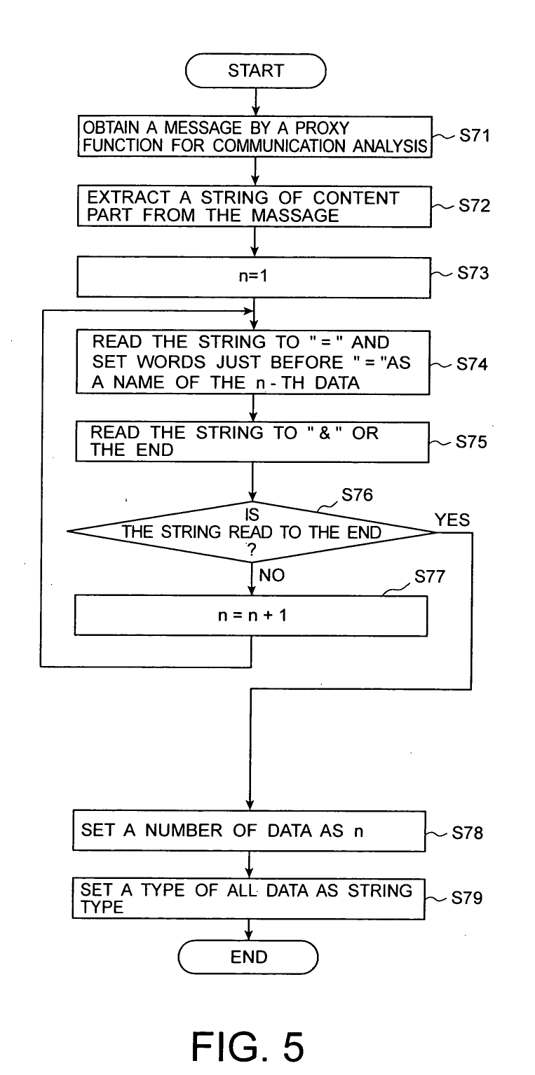

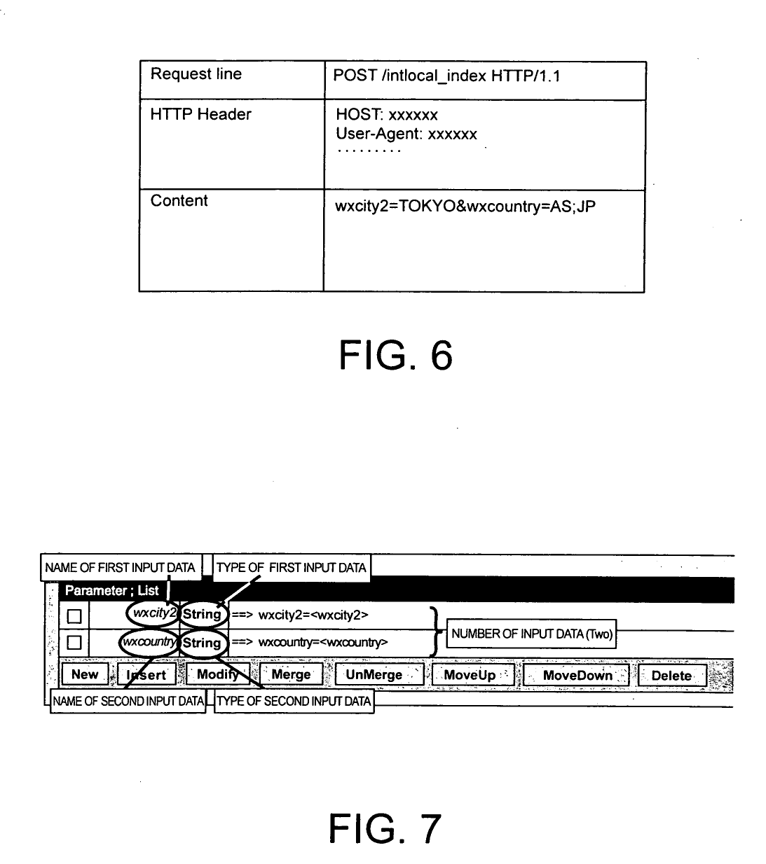

FIG. 5 is a flow chart of an analysis processing of POST protocol. FIG. 6 is one example of request data of POST protocol. FIG. 7 is one example of analysis result of the request data of FIG. 6. In the case that the Web application adopts HTTP/POST protocol, a proxy function unit 55 for communication analysis in FIG. 1 executes processing in FIG. 5. First, the proxy function unit 55 obtains a message in FIG. 6 (S71), extracts a string of content part from the message (S72), and analyzes the string (S73˜S77). As a result, as shown in FIG. 7, a number of request data and a name of request data are analyzed and set as an original form of request data to the Web application (S78, S79).

As for response data of HTML from the Web application, the analysis function unit 50 sets all of HTML to be replied as string type data of one unit and uses the string type data as an original form of a response from the Web application to the Web service. Furthermore, the analysis function unit 50 extracts a plurality of sets each including a tag, a property and data contents as a tree structure. A generation function unit adds an identifier to each set, and displays the plurality of sets. This identifier is a combination of a first address and a second address. The first address represents a position from a root in the tree structure. The second address represents a relative position from an arbitrary position in the tree structure. Briefly, the identifier represents an address of each data position in the tree structure.

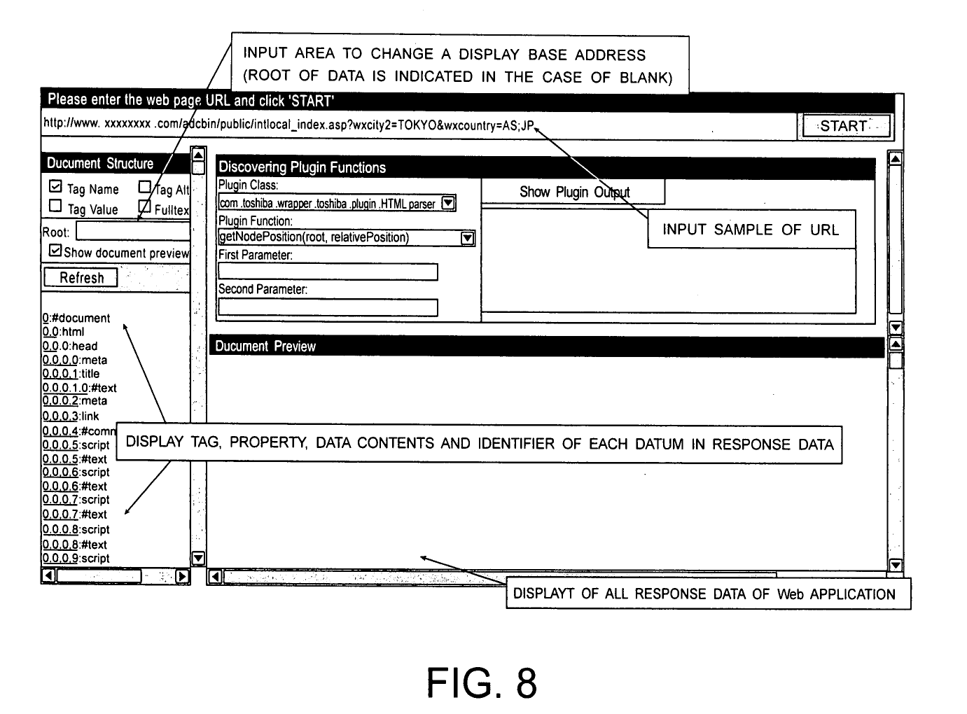

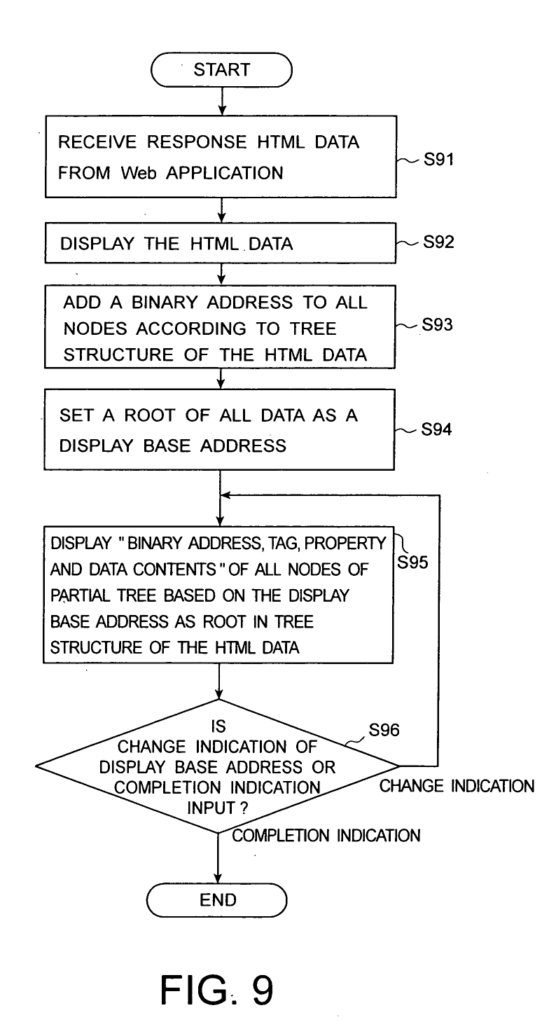

FIG. 8 is one example of a display on which analysis result of response data is output. FIG. 9 is a flow chart of display processing of analysis result of response data. The generation function unit 60 executes processing of FIG. 9. First, the generation function unit 60 displays Web page contents of HTML data as shown in the right lower part of FIG. 8 (S91, S92), and displays the plurality of sets including the tag, the property, the data contents and the identifier of binary address (combination of the first address and the second address) in the graph structure of HTML data (S93˜S95). Furthermore, by indicating a display base address in Root area as shown in the left upper part of FIG. 8 (S96), the plurality of sets is displayed based on a relative position from the display base address (S95).

A data name and a type shown in FIGS. 3 and 7 may be modified from the original form by string editing such as “editor”. Furthermore, a data mapping rule to convert a value of each datum may be indicated and added to request data conversion information. Briefly, the generation function unit 60 includes a modification function unit 65 (It is also called “modification function”). The modification function unit 65 modifies at least one of a number of the request data, a number of the response data, a name, and a type of each datum in response to a user's operation from a pointing device such as a mouse or an input apparatus such as a keyboard. Furthermore, the modification function unit 65 previously receives an indication of the mapping rule to convert contents of the transfer data.

Furthermore, the generation function unit 60 receives an indication of the identifier representing a part of the response data to be sent to the Web service. In display or indication by the identifier, in the case that the end of the first address is a predetermined character representing an arbitrary address, all data specified by the second address also included in all data specified by the first address is data specified by the combination of the first address and the second address. (For example, in the case of address “0.1.2.34.5”, the end of the address is “5”. Furthermore, in the case of address “/user/hsgw/patents/wsgw/sample.txt”, the end of the address is “sample.txt”.)

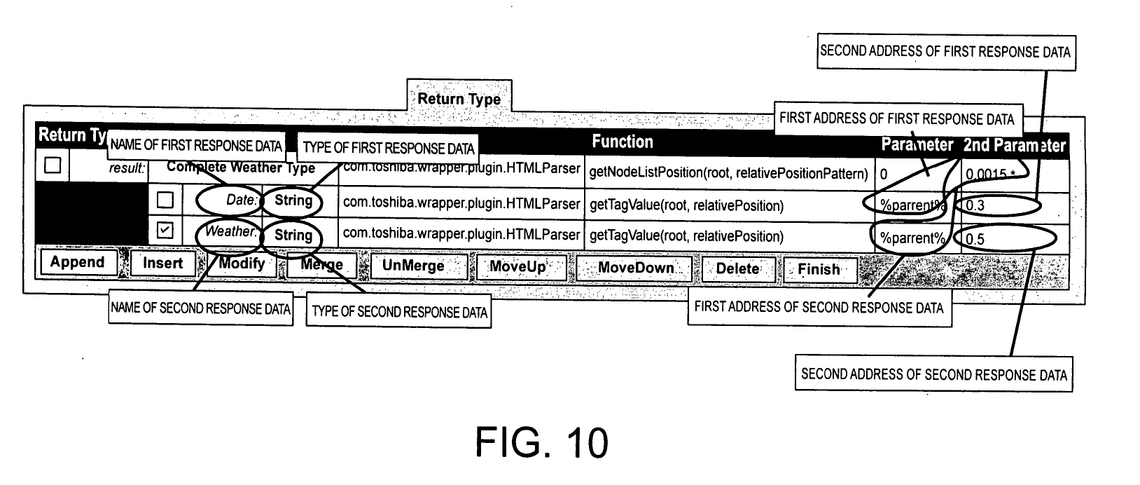

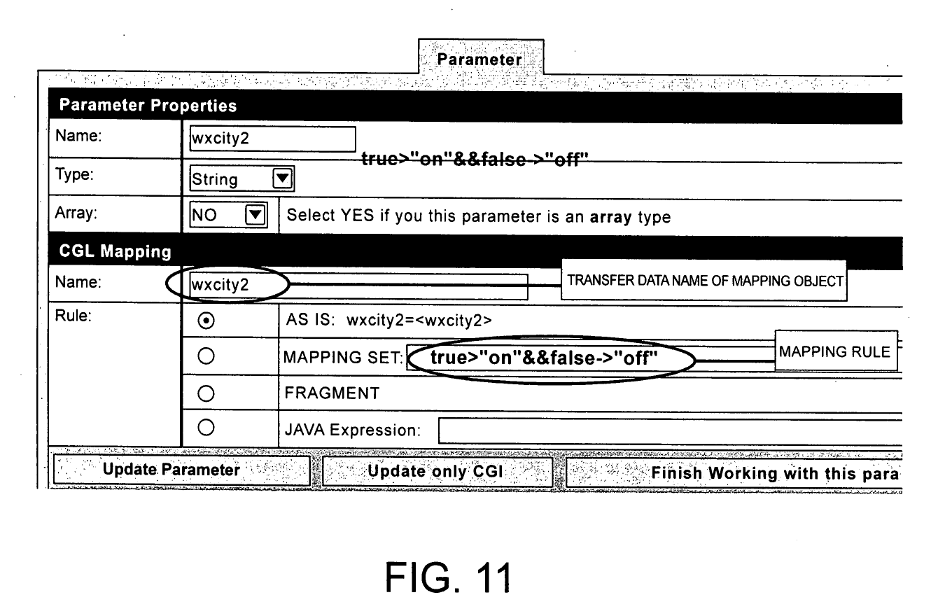

FIG. 10 is one example of identifiers added to each analyzed datum on a display. FIG. 11 is one example of a mapping rule to convert contents of transfer data on a display. For example, by referring to a display of FIG. 8, in the case that the response data is modified on another window screen same as FIGS. 3 and 7, an identifier, a data name and a type are registered to the request data conversion information. Concretely, as shown in FIG. 10, the identifier is indicated by the first address and the second address. Furthermore, as shown in the first address “%parrent%0.0015*” of the first response data of FIG. 10, a predetermined special character “*” representing arbitrariness (wild card) is indicated at the end of the first address. In this case, in all data specified by the first address except for the end, any of a tag, a property, and data contents of data specified by the second address is registered to response data conversion information. In the same way as the request data, the mapping rule is also added to the response data conversion information by indication on a screen of FIG. 11.

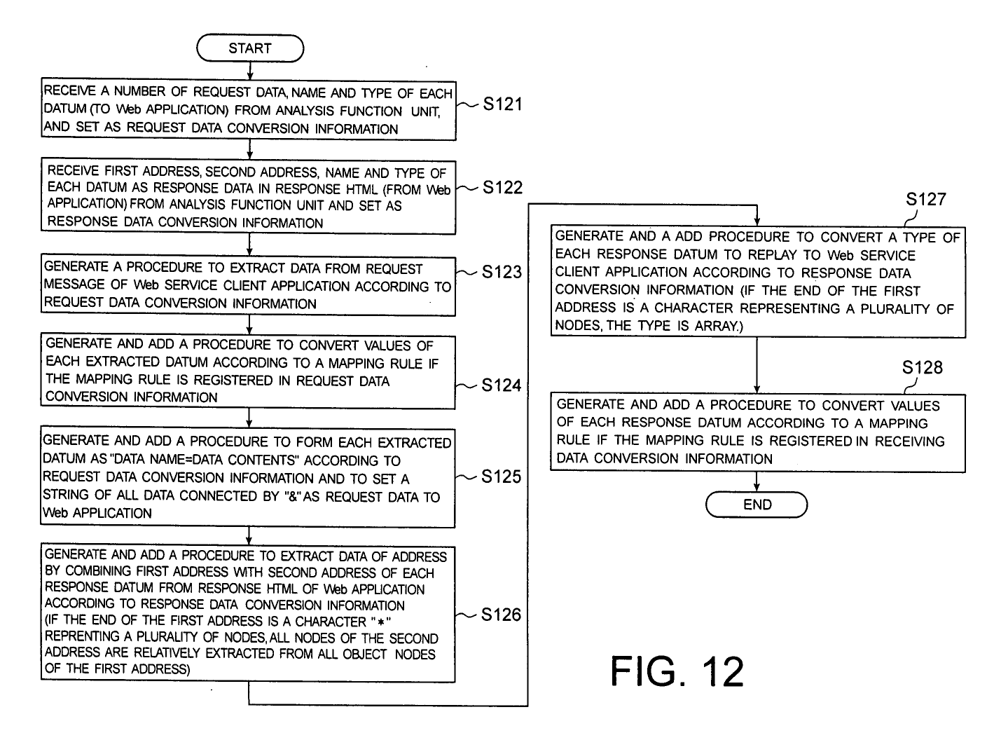

FIG. 12 is a flow chart of generation processing of a conversion unit. The generation function unit 60 (It is also called “generation function”) executes processing of FIG. 12 based on a rule of connection protocol analyzed by the analysis function unit 50, and a modification and a mapping rule given by the modification function unit 65. Concretely, the generation function unit 60 generates individual protocol conversion units 73 and 75 to apply communication of the Web service to communication of the Web application (FIG. 1). In FIG. 12, based on the request data conversion information and response data conversion information from the analysis function unit 50 (S121˜S123) and the mapping rule indicated (S124), a procedure to convert the request data and the response data is generated (S124˜S128).

The individual protocol conversion units 73 and 75, a form of computer program module, are respectively distinct to the Web applications 21 and 22. A sample of request data was given to the individual protocol conversion units 73 and 75 from the analysis function unit 50. Concretely, the generation function unit 60 generates the individual protocol conversion unit to invoke (receive) a number of request data, a name of each datum, and a type (string type) of each datum analyzed by the analysis function unit 50. Furthermore, the generation function unit 60 generates the individual protocol conversion units 73 and 75 to invoke (receive) the response data of which number is one and type is string. In the present embodiment, the individual protocol conversion units 73 and 75 may not be distinct to the Web applications 21 and 22, and may not be realized as the computer program module.

The individual protocol conversion units 73 and 75 operate on a common protocol conversion unit 70 in the gateway system 4, and operate for a client side of the Web service in the same way as a server side of the Web application. The common protocol conversion unit 70 offsets a difference of general data format between HTTP and SOAP. The individual protocol conversion units 73 and 75 process feature peculiar to the Web application and the Web service except for the general data format.

For Web service client applications 31 and 32, the individual protocol conversion units 73 and 75 in the gateway system 4 convert data and protocol. Concretely, request data of SOAP format from the Web service is converted to HTTP data of GET format or POST format of the Web application, and sent to the (corresponding) Web application (with activation if necessary). Furthermore, when a server of the Web application sends back response data, HTML format of the response data (HTTP) is converted to SOAP format of the Web service, and sent to the Web service client application 31 or 32 as a request source.

As mentioned-above, in the present embodiment, an example of transfer data of the web application such as HTTP protocol is automatically analyzed, and this analysis result is used for conversion for communication of the Web service such as SOAP protocol. Accordingly, a development result of the web service equivalent to the Web application can be easily acquired without special knowledge and skill, and system development cost and time can be greatly reduced.

In the present embodiment, analysis and conversion means is packaged in the server side or the client side as a hardware or a process different from a server and a client, or as an independent computer system different from both sides. Accordingly, development and maintenance can be independently prosecuted from a program of the Web application and the Web service.

Furthermore, in the present embodiment, the user's modification is received by using the analysis result as an original form. Accordingly, for example, by excluding an image element from the response data of the Web application, only necessary part can be returned to a client of the web service. Briefly, conversion matched with actual condition of use can be easy.

Furthermore, in the present embodiment, a mapping rule to convert a value of transfer data is indicated. Accordingly, for example, in the case that a value for menu selection is an identification number in the Web application but it is a name in the Web service, a difference between both formats can be offset.

Especially, based on HTML data replied from the Web application, a part of the HTML data is indicated as response data to the Web service by using the identifier (binary address) representing each datum position in the tree structure. Accordingly, for example, response data including an image for human can be converted to a meaningful string only (excluding the image) suitable for a reply to the Web service client application. For example, in HTML, weather, the expected maximum temperature and a precipitation possibility are respectively presented as a look by character and picture. In this case, the character of the weather and the precipitation possibility are set as response data to the Web service.

Furthermore, in the case of a plurality of specified or unspecified data to be replied, the first address including an arbitrary character at the end is used. Concretely, in all data specified by the first address in the graph structure, a relative position of each datum is indicated by the second address. For example, in the case that a product name, a performance and a price are replied for a plurality of products matched with requirement specification, the head of data of each product is represented by the first address, and a product name and a price in the data of each product are represented by the second address. Accordingly, a group of pairs each comprising the product name and the price of a plurality of products can be indicated as the response data.

For embodiments of the present invention, the processing of the present invention can be accomplished by a computer-executable program, and this program can be realized in a computer-readable memory device.

In embodiments of the present invention, the memory device, such as a magnetic disk, a floppy disk, a hard disk, an optical disk (CD-ROM, CD-R, DVD, and so on), an optical magnetic disk (MD and so on) can be used to store instructions for causing a processor or a computer to perform the processes described above.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device. The component of the device may be arbitrarily composed.

In embodiments of the present invention, the computer executes each processing stage of the embodiments according to the program stored in the memory device. The computer may be one apparatus such as a personal computer or a system in which a plurality of processing apparatuses are connected through a network. Furthermore, in the present invention, the computer is not limited to a personal computer. Those skilled in the art will appreciate that a computer includes a processing unit in an information processor, a microcomputer, and so on. In short, the equipment and the apparatus that can execute the functions in embodiments of the present invention using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

1. An information processing apparatus, comprising:
an analysis unit configured to receive a sample of request data sent from a browser to a Web application, the browser and the Web application communicating data using a predetermined protocol, the Web application receiving the request data using a predetermined data extraction method, and to analyze a rule of the predetermined protocol based on the sample, the rule including a number of the request data, a name of the request data, and a format of response data corresponding to the request data; and
a generation unit configured to generate a protocol converter to connect a communication of a Web service with a communication of the Web application based on the rule.

2. The information processing apparatus according to claim 1,
wherein the predetermined protocol is HTTP protocol, and
wherein the predetermined data extraction method is GET method or POST method.

3. The information processing apparatus according to claim 1,
wherein the Web application generates the response data in response to the request data.

4. The information processing apparatus according to claim 1,
wherein said analysis unit is packaged as a proxy server between a server system of the Web application and a client system of the browser.

5. The information processing apparatus according to claim 1,
wherein said protocol converter receives the request data by invoking the number of data, the name of each datum, and a type of each datum as a string.

6. The information processing apparatus according to claim 1,
wherein said protocol converter receives the response data of which a number of datum is one and a type of each datum is a string.

7. The information processing apparatus according to claim 1, further comprising:
a modification unit configured to modify at least one of the number of the request data, the name of the request data, and the format of response data in response to a user's operation.

8. The information processing apparatus according to claim 7,
wherein said modification unit indicates a mapping rule to convert contents of at least one of the request data and the response data in response to the user's operation.

9. The information processing apparatus according to claim 7,
wherein said analysis unit extracts a plurality of sets each including a tag, a property, and data contents from the response data having a tree structure,
wherein said generation unit adds an identifier representing a datum address in the tree structure to each set, the identifier being a combination of a position from a root as a first address and a relative position from an arbitrary position as a second address, and displays the plurality of sets each to which the identifier is added, and
wherein said modification unit indicates the identifier added to the set to be transferred to the Web service in response to the user's operation.

10. The information processing apparatus according to claim 9,
wherein, if the end of the first address is a predetermined character representing an arbitrary address, all data specified by the second address included in all data specified by the first address are represented by the identifier.

11. An information processing method, comprising:
receiving a sample of request data sent from a browser to a Web application, the browser and the Web application communicating data using a predetermined protocol, the Web application receiving the request data using a predetermined data extraction method;
analyzing a rule of the predetermined protocol based on the sample, the rule including a number of the request data, a name of the request data, and a format of response data corresponding to the request data; and
generating a protocol converter to connect a communication of a Web service with a communication of the Web application based on the rule.

12. The information processing method according to claim 11,
wherein the predetermined protocol is HTTP protocol, and
wherein the predetermined data extraction method is GET method or POST method.

13. The information processing method according to claim 11,
wherein the Web application generates the response data in response to the request data.

14. The information processing method according to claim 11,
wherein said protocol converter receives the request data by invoking the number of data, the name of each datum, and a type of each datum as a string.

15. The information processing method according to claim 11,
wherein said protocol converter receives the response data of which a number of datum is one and a type of each datum is a string.

16. The information processing method according to claim 11, further comprising:
modifying at least one of the number of the request data, the name of the request data, and the format of response data in response to a user's operation.

17. The information processing method according to claim 16, further comprising:
indicating a mapping rule to convert contents of at least one of the request data and the response data in response to the user's operation.

18. The information processing method according to claim 16, further comprising:
extracting a plurality of sets each including a tag, a property and data contents from the response data having a tree structure;
adding an identifier representing a datum address in the tree structure to each set, the identifier being a combination of a position from a root as a first address and a relative position from an arbitrary position as a second address;
displaying the plurality of sets each to which the identifier is added; and
indicating the identifier added to the set to be transferred to the Web service in response to the user's operation.

19. The information processing method according to claim 18,
wherein, if the end of the first address is a predetermined character representing an arbitrary address, all data specified by the second address included in all data specified by the first address are represented by the identifier.

20. A computer program product, comprising:
a computer readable program code embodied in said product for causing a computer to process information, said computer readable program code comprising:
a first program code to receive a sample of request data sent from a browser to a Web application, the browser and the Web application communicating data using a predetermined protocol, the Web application receiving the request data using a predetermined data extraction method;
a second program code to analyze a rule of the predetermined protocol based on the sample, the rule including a number of the request data, a name of the request data, and a format of response data corresponding to the request data; and
a third program code to generate a protocol converter to connect a communication of a Web service with a communication of the Web application based on the rule.
